(19) United States
(12) Patent Application Publication
(10) Pub. No.: US 2016/0251848 A1
(43) Pub. Date: Sep. 1, 2016

(54) SYSTEM AND METHOD FOR ANCHORING A STRUCTURE

(71) Applicant: MASONRY SOLUTIONS INTERNATIONAL, Cockeysville, MD (US)

(72) Inventors: Wayne Timothy Ruth, Cockeysville, MD (US); Matthew Kirby Ruth, Cockeysville, MD (US)

(21) Appl. No.: 15/028,628

(22) PCT Filed: Oct. 10, 2014
(86) PCT No.: PCT/US14/60115

§ 371 Date: Apr. 11, 2016

Related U.S. Application Data
(60) Provisional application No. 61/889,918, filed on Oct. 11, 2013.

(51) Int. Cl. E04B 1/41; F16M 13/02

(52) U.S. Cl. CPC E04B 1/4114; F16M 13/02

(57) ABSTRACT

A system and method for providing an anchor in a structure includes a hollow spline, which may include exterior threading, and an associated containment sleeve. The spline and sleeve are positionable within a borehole in the structure. Curable fluid is injected through the hollow spline and into the containment sleeve and allowed to cure.

### BACKGROUND

1. Field

The present invention relates generally to systems and methods for anchoring structures and more particularly to fabric anchoring techniques.

2. Background

Anchor systems are used for reinforcing and connecting structural systems such as masonry walls, or to attach other components or structures. In one approach, a hole is drilled into the structure to be anchored. An anchor spline, surrounded by a fabric containment tube, is inserted into the hole, and a curable injection material is injected. The fabric tube fills with the injected material and expands to lock within the host structure. Generally, some portion of the injected material passes through pores in the fabric to bond the anchor to the surrounding borehole.

### SUMMARY

An aspect of an embodiment of the present invention includes a hollow spline and a flexible containment sleeve, disposed around the hollow spline and in fluid communication with a distal opening of the hollow spline and configured such that a curable injection fluid injected through a proximal end of the hollow spline will flow into the flexible containment sleeve and, when cured, secure the spline in place within the borehole. In an embodiment, the hollow spline includes exterior threading.

An aspect of an embodiment of the present invention includes a method for anchoring a structure including drilling a hole in the structure, placing a hollow spline in the hole, placing a flexible containment sleeve in the hole and surrounding the hollow spline, injecting a curable material through the hollow spline and into the flexible containment sleeve to expand the flexible containment sleeve to substantially fill the hole, and curing the curable material to bond the hollow spline and flexible containment sleeve in place within the hole.

### DESCRIPTION OF THE DRAWINGS

Other features described herein will be more readily apparent to those skilled in the art when reading the following detailed description in connection with the accompanying drawings, wherein:

FIG. 1 schematically illustrates an anchor system in accordance with an embodiment.

### DETAILED DESCRIPTION

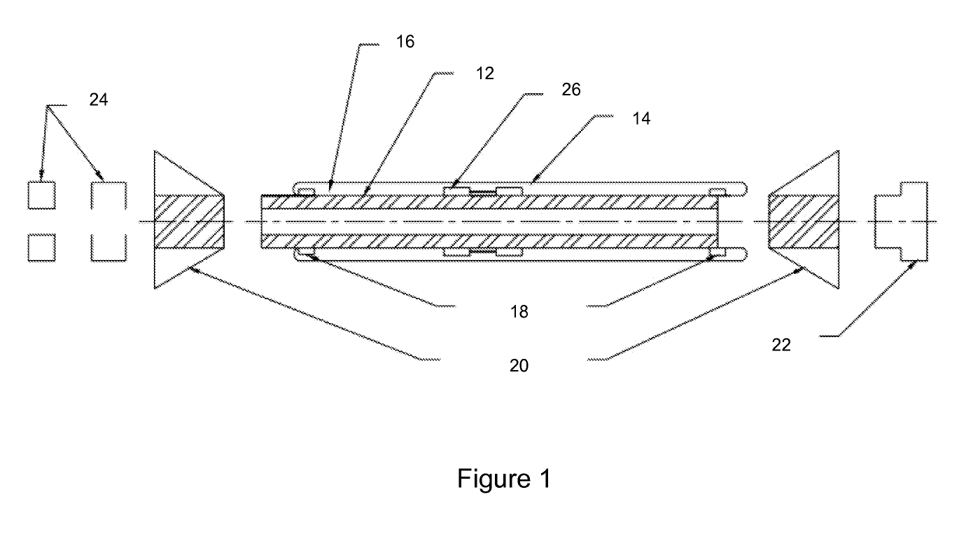

An anchoring system 10 in accordance with an embodiment is illustrated in FIG. 1. A spline 12, forming a core of the anchor is hollow and threaded. In an embodiment, the core may be cold forged or cold rolled. The threading may be, for example, a Unified Coarse (UNC) thread pattern, though other thread types may be used in accordance with the specific application. The inner diameter of the central through-hole should be selected to be sufficiently large to allow injection of a curable material there through. In a non-limiting example, a half-inch outer diameter rod having a quarter-inch internal diameter could be used as the spline 12. The outer threading is selected to be compatible with fasteners such as nuts to secure the assembly to the structure, or alternately, compatible with other assemblies to be mounted to the anchor.

Arranged outside of the spline 12 is a containment sleeve 14. The containment sleeve 14 should generally be flexible and strong, and be sufficiently permeable to allow some degree of flow through by the curable material. The containment sleeve 14 may be made from any of a number of appropriate materials, including carbon and steel fabrics or meshes. In embodiments, woven and nonwoven fabrics, which may be reinforced with strength members such as carbon fiber, steel, and/or synthetic fibers such as Kevlar and the like, could all be employed.

The space between the spline 12 and the containment sleeve 14 is filled with a curable injection material 16. The material 16 may include a variety of flowable cement and/or lime based liquid mixes, which may also be referred to as grouts. The material 16 may be selected to exhibit various properties, depending on the particular installation. For example, waterproofing, fire resistance and/or corrosion resistance may be important in certain situations. The material 16 may also be selected to have a coefficient of thermal expansion, a water permeability, a compressive strength, and/or vapor transmission that is matched to the surrounding material. In an embodiment, the installation method includes on site and/or laboratory testing of the material of the structure being reinforced to determine appropriate characteristics of the fill. As will be appreciated, the fill should substantially fill the borehole.

In the embodiment of FIG. 1, additional optional structures are included in the anchoring system 10. At each end of the spline 12, a respective compression ring 18 is used to fix the containment sleeve 14 to the spline 12, and to assist in containing the injection material 16 within the containment sleeve 14. A threaded compression member 20 is likewise optionally connected at each end of the spline 12. At the distal end, a cap 22 may be provided. At the proximal end, customizable connection assemblies 24 may also be provided. As will be appreciated, the connection assemblies 24 may be selected for use with various structures to be attached to the anchor.

In one embodiment, a tapered dowel with internal threading at one or both ends is used in conjunction with the compression ring 18 to secure the containment to one or both ends of the anchor. The tapered dowel is threaded onto an end of the spline's thread. A compression ring is then slid down the spline, with the containment sleeve 14 tucked under the ring. The ring and sleeve are then pushed onto the frame of the dowel, securing the fabric. This approach may simplify assembly by eliminating the need for plastic fittings, and may tend to increase both the tensile and shear strength of the anchor.

FIG. 1 further illustrates an embodiment in which one or more strain gages 26 are included in the anchoring structure to monitor strain in the spline 12. They may likewise be incorporated into the material of the containment sleeve 14. They may be arrayed along the length of the anchor to provide location specific strain information relevant to selected segments of the system, depending on the expected stress load. These strain gages may be, for example, RFID based wireless and unpowered strain gages such as those available from Phase IV Engineering of Boulder, Colo. Alternately, an electrical connection could be provided as necessary or desirable.

Other telemetric devices may similarly be incorporated, either in conjunction with or independently of the strain gages. In an example, RFID tags can be used to uniquely or generally identify a particular anchor installed in a particular location. In an embodiment, the tag may be configured to be threadably connected to the spline 12. Accelerometers, GPS, magnetic compasses and/or other devices that are useful for monitoring position and/or movement of the structure may likewise be incorporated into the anchoring system and may be wirelessly or electrically pollable using an appropriate reader.

In an embodiment, the drilled hole into which the anchoring system is inserted includes a uniform diameter for an initial portion, then a wider portion at the distal end. This approach may improve the pullout capacity and may furthermore reduce the importance of a strong bond between the injected material 16 and the surrounding material. Such an approach may find use, for example, in a structure that tends to experience uplift, such as, for example, a structure in a high wind area. A tapered hole of this type may be made using, for example, the Gruenstark undercut coring system, available from Gurenstark of Cockeysville, Md.

### Example 1

In a particular example of an embodiment, a 12″ long, 1″ diameter dry cored hole is drilled into a masonry structure. The hole includes a reverse taper at the distal end to 1¼″ diameter. A polyester blend fabric containment that is constructed to have an outer diameter of greater than 1″ when expanded is used as the containment sleeve 14. A ½″-13 hollow, cold rolled, stainless type 304 UNC threaded spline 12 is placed within the fabric containment sleeve 14. The sleeve 14 is fixed to the ends of the spline 12 using compression rings and tapered dowels as described above. At the proximal end, the dowel includes a ¼″ through hole at the center to allow for injection of the injection material 16. At the distal end, the dowel is closed at its end, but includes a ¼″ hole through its side to allow for ejection of the injection material into the containment sleeve 14.

Those skilled in the art will appreciate that the disclosed embodiments described herein are by way of example only, and that numerous variations will exist. The invention is limited only by the claims, which encompass the embodiments described herein as well as variants apparent to those skilled in the art.

1. An anchor system for use within a borehole in a structure comprising:
a hollow spline having an exterior threading formed by cold rolling;
a flexible containment sleeve, disposed around the hollow spline and in fluid communication with a distal opening of the hollow rod and configured such that a curable injection fluid injected through a proximal end of the hollow spline will flow into the flexible containment sleeve and, when cured, secure the spline in place within the borehole.

2. An anchor system as in claim 1, further comprising:
a tapered compression member, internally threaded to engage external threads of the hollow spline at a distal end thereof and having a passageway therethrough configured to allow the fluid communication between the distal opening of the hollow rod and the flexible containment sleeve when the compression member is positioned at the distal end of the hollow spline.

3. An anchor system as in claim 1, wherein the containment sleeve is secured to the hollow spline by way of a pair of compression rings, each secured to respective ends of the hollow spline.

4. An anchor system as in claim 1, further comprising at least one sensor configured and arranged to measure at least one characteristic of a structural component of the anchor system within the borehole.

5. An anchor system as in claim 4, wherein the at least one sensor comprises an RFID device that is configured and arranged to be wirelessly interrogated by an associated reading device.

6. A method of anchoring a structure, comprising:
drilling a hole in the structure;
placing a hollow spline having exterior threading formed by cold rolling in the hole;
placing a flexible containment sleeve in the hole and surrounding the hollow spline;
injecting a curable material through the hollow spline and into the flexible containment sleeve to expand the flexible containment sleeve to substantially fill the hole; and
curing the curable material to bond the hollow spline and flexible containment sleeve in place within the hole.

7. A method as in claim 6, wherein the hollow spline comprises exterior threading.

8. A method as in claim 7, wherein the flexible containment sleeve is fixed to the hollow spline by way of compression rings configured and arranged to engage the exterior threading of the hollow spline.

9. A method as in claim 6, further comprising, prior to the injecting, measuring a characteristic of materials surrounding the hole and selecting the curable material to have a respective characteristic matching the measured characteristic.
